(19) United States
(12) Patent Application Publication
(10) Pub. No.: US 2012/0267284 A1
(43) Pub. Date: Oct. 25, 2012

(54) PALLET SKIRT

(75) Inventors: Kevin Thimmesch, Overland Park, KS (US); Brendan Matthew Dillon, Overland Park, KS (US); Jack Kliewer, Little River, KS (US)

(73) Assignee: North American Salt Company, Overland Park, KS (US)

(21) Appl. No.: 13/092,000

(22) Filed: Apr. 21, 2011

(51) Int. Cl. B65D 19/00; B23P 17/04

(52) U.S. Cl. 206/597; 29/428

(57) ABSTRACT

A pallet skirt for covering side portions of a pallet and for providing access for lifting of the pallet via forks of a pallet lifting device includes a skirt body with opposite top and bottom margins. The skirt body includes first and second pairs of opposite side walls, with each of the side walls presenting opposite inner and outer faces. The side walls are configured to cover portions of product stacked on the pallet and to cover the side portions of the pallet. The side walls of at least one of the side wall pairs defines therethrough a pair of spaced apart fork-receiving recesses that extend between the inner and outer faces to thereby provide fork access to the pallet through the side wall when the skirt body is disposed about the pallet. A blank for forming such a pallet skirt is also disclosed. A method of labeling a palleted product such that the labeled pallet remains moveable via forks is also taught.

### BACKGROUND OF THE INVENTION

1. Field of the Invention

The present invention relates generally to a pallet skirt for disposition about a loaded pallet. More specifically, the present invention concerns a pallet skirt that covers side portions of a loaded pallet and that includes a plurality of side walls, with at least one side wall defining therethrough a pair of spaced apart fork-receiving recesses to provide fork access to the pallet through the side wall for mechanical lifting of the skirted pallet.

2. Discussion of the Prior Art

Those of ordinary skill in the art will appreciate that many consumer and industrial products are loaded onto pallets to move through at least part of a supply chain in unit load form. For example, products may be loaded onto pallets for storage, shipment, and/or retail display. Loaded pallets may be easily moved by mechanical lifting of the pallet via forks of a pallet lifting device (e.g., a forklift or a pallet jack). For a variety of reasons, it can also be helpful to label palleted products with a pallet skirt or wrap.

Traditional pallet skirts or wraps have been satisfactory in some respects, but have also presented numerous drawbacks. For example, one traditional pallet wrap has been constructed in an open box top design. This type of wrap sits on top of the pallet and is disposed on the pallet prior to product being loaded onto the pallet. Automatic palletizers cannot be used with wraps of the open box top design, instead requiring manual loading of product onto the pallet. In addition, box-type pallet wraps leave the unsightly pallet exposed below the loaded product.

As palleted products have become more common in retail settings, a wraparound solid pallet skirt has come to market. This type of skirt is typically placed around the base of the pallet at a retail location, after any loading, shipment, or storage of the palleted product. Once a known wraparound solid skirt is placed around the base of the pallet, the pallet cannot be moved with a conventional forklift or pallet jack without first removing the skirt.

### SUMMARY

According to an aspect of the present invention, a pallet skirt for covering side portions of a pallet as well as for providing access for lifting of the pallet via forks of a pallet lifting device is disclosed. The unique pallet skirt of the present invention may be disposed about the pallet subsequent to product being loaded onto the pallet, allowing for efficient use of automatic palletizers. The pallet skirt and the palleted product may be at least partially wrapped with wrapping material, which may protect the product (especially bottom layers of the product) during shipping.

A loaded pallet including the pallet skirt of the present invention may be moved into position via forks of a pallet lifting device, and does not require reliance on a third party (such as a retailer) to apply the skirt after moving. The inventive skirt also need not be removed for subsequent moving of the loaded pallet via forks of a pallet lifting device. The pallet skirt of the present invention not only covers unsightliness of the pallet, but also provides additional messaging space relative to prior art skirts.

More particularly, according to one aspect of the present invention, a pallet skirt is provided for covering side portions of a pallet and for providing access for mechanical lifting of the pallet via forks of a pallet lifting device. The pallet skirt includes a skirt body that presents opposite top and bottom margins. The skirt body includes a first pair of opposite side walls and a second pair of opposite side walls. Each of the side walls presents opposite inner and outer faces. The side walls are configured to cooperatively cover portions of product stacked on the pallet and to cooperatively cover side portions of the pallet, such that a lowermost part of the bottom margin of the skirt body is in line with a bottom surface of the pallet, when the skirt body is disposed about the pallet. The side walls of at least one of the side wall pairs defines therethrough a pair of spaced apart fork-receiving recesses that extend between the inner and outer faces and thereby provide fork access to the pallet through the side wall when the skirt body is disposed about the pallet.

Another aspect of the present invention involves a blank for forming a pallet skirt, where the skirt is to be configured to cover side portions of a pallet and to provide access for mechanical lifting of the pallet via forks of a pallet lifting device when the skirt is disposed about the pallet. The blank includes an elongated sheet of skirt material. The sheet presents opposite top and bottom margins. The sheet includes first and second side wall panels, where the side wall panels are disposed laterally adjacent one another and have a first fold line disposed therebetween. Each of the side wall panels extends substantially continuously between the top and bottom margins. The sheet further includes a connection flap that is disposed laterally adjacent one of the side wall panels and has a second fold line disposed therebetween. The connection flap is configured to connect with another side wall panel of either the same sheet or another sheet. At least one of the side wall panels includes a pair of spaced apart recess-defining margins defined therein to selectively present a recess margin that is spaced from a lowermost part of the bottom margin.

A further aspect of the present invention concerns a method of labeling product on a pallet such that the labeled pallet is moveable via forks of a pallet lifting device. The labeling method includes the step of disposing a labeling pallet skirt about the pallet to cover portions of the product and to cover side portions of the pallet, such that a lowermost part of a bottom margin of the skirt is in line with a bottom surface of the pallet. The skirt includes a plurality of side walls, where at least a pair of opposite side walls defines therethrough a pair of spaced apart fork-receiving recesses through which forks can extend to access and lift the labeled pallet while the skirt is disposed about the pallet.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is an isometric view of a pallet loaded with product and including a pallet skirt constructed in accordance with the principles of a preferred embodiment of the present invention disposed thereabout, with portions of the product and the pallet skirt being encased in a wrapping material;

FIG. 2a is an isometric view of the pallet skirt shown in a collapsed condition, with arrows depicting a direction of expansion for preparing the collapsed skirt for disposition about a pallet;

FIG. 2b is an isometric view of the pallet skirt shown in an intermediate condition, with arrows depicting a further direction of expansion for preparing the skirt for disposition about a pallet;

FIG. 2c is an isometric view of the pallet skirt shown in an expanded condition, with arrows depicting the directions of expansion as the skirt is manipulated from the collapsed condition to the expanded condition;

FIG. 3 is an isometric view of the pallet skirt shown in the expanded condition disposed above the loaded pallet and ready for disposition about the loaded pallet;

FIG. 4 is an isometric view of the pallet skirt disposed about the loaded pallet, similar in many respects to the view of FIG. 1, but taken from the opposite perspective and being depicted without the wrapping material;

FIG. 5 is an isometric view of the pallet skirt disposed about an unloaded pallet depicted in broken lines, similar in many respects to the view of FIG. 1, but being depicted without the loaded product or the wrapping material;

FIG. 6 is a generally side elevational view of the pallet skirt disposed about the unloaded pallet depicted in broken lines as shown in FIG. 5, particularly illustrating portions of a first side wall of the skirt;

FIG. 7 is a generally side elevational view of the pallet skirt disposed about the unloaded pallet depicted in broken lines as shown in FIGS. 5 and 6, taken from a different side from the view of FIG. 6, and particularly illustrating portions of a second side wall of the skirt;

FIG. 8 is a generally top-down plan view of the pallet skirt disposed about the unloaded pallet depicted in broken lines as shown in FIGS. 5-7, particularly illustrating connection flaps underlying portions of respective first side walls;

FIG. 9 is a generally bottom-up plan view of the pallet skirt disposed about the unloaded pallet depicted in broken lines as shown in FIGS. 5-8, particularly illustrating again the connection flaps underlying portions of respective first side walls;

FIG. 10a is a generally side elevational view of an embodiment of a blank for forming the pallet skirt constructed in accordance with the principles of a preferred embodiment of the present invention;

FIG. 10b is a generally side elevational view of another embodiment of a blank for forming a pallet skirt constructed in accordance with the principles of a preferred embodiment of the present invention;

FIG. 11 is an enlarged, fragmentary, isometric view of a portion of the blank shown in FIG. 10a, particularly illustrating details of construction of an embodiment of a connection flap and a corresponding connection surface;

FIG. 12 is an isometric view of a pallet skirt constructed in accordance with the principles of another embodiment of the present invention, similar in many respects to the pallet skirt of FIG. 5, but being depicted without the pallet;

FIG. 13 is an isometric view of a pallet skirt constructed in accordance with the principles of another embodiment of the present invention, similar in many respects to the pallet skirt of FIG. 5, but being depicted without the pallet; and

FIG. 14 is an isometric view of a pallet skirt constructed in accordance with the principles of another embodiment of the present invention, similar in many respects to the pallet skirt of FIG. 5, but being depicted without the pallet.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

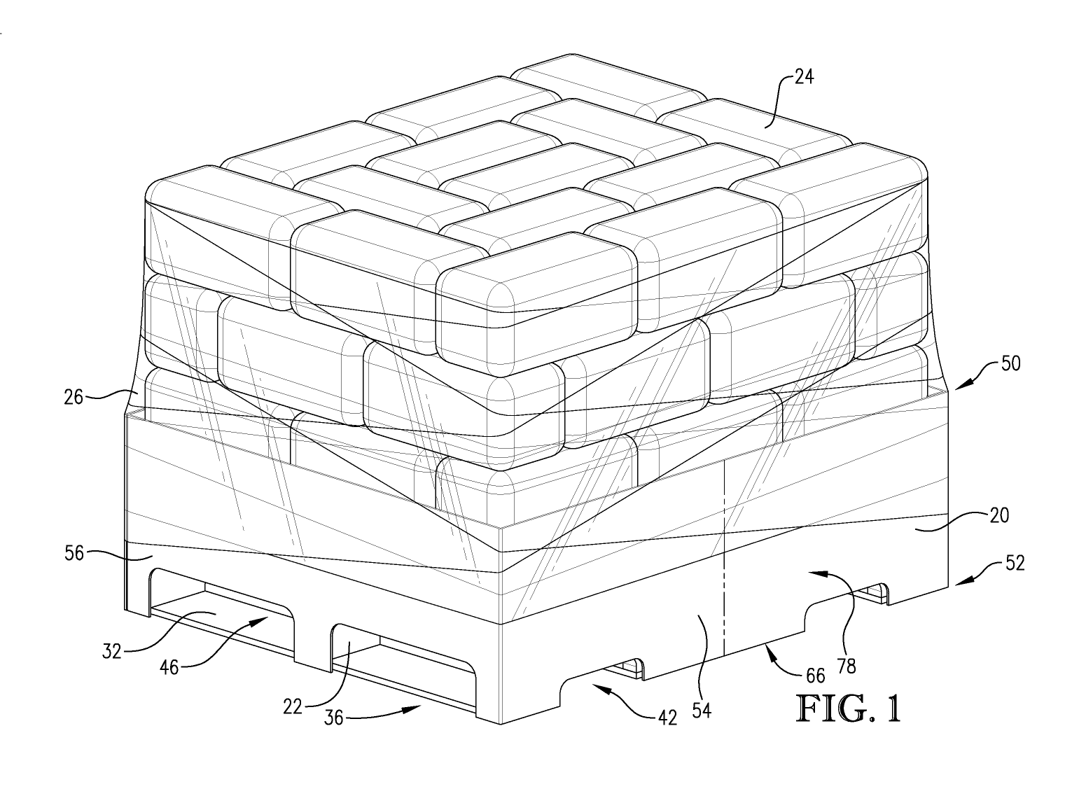

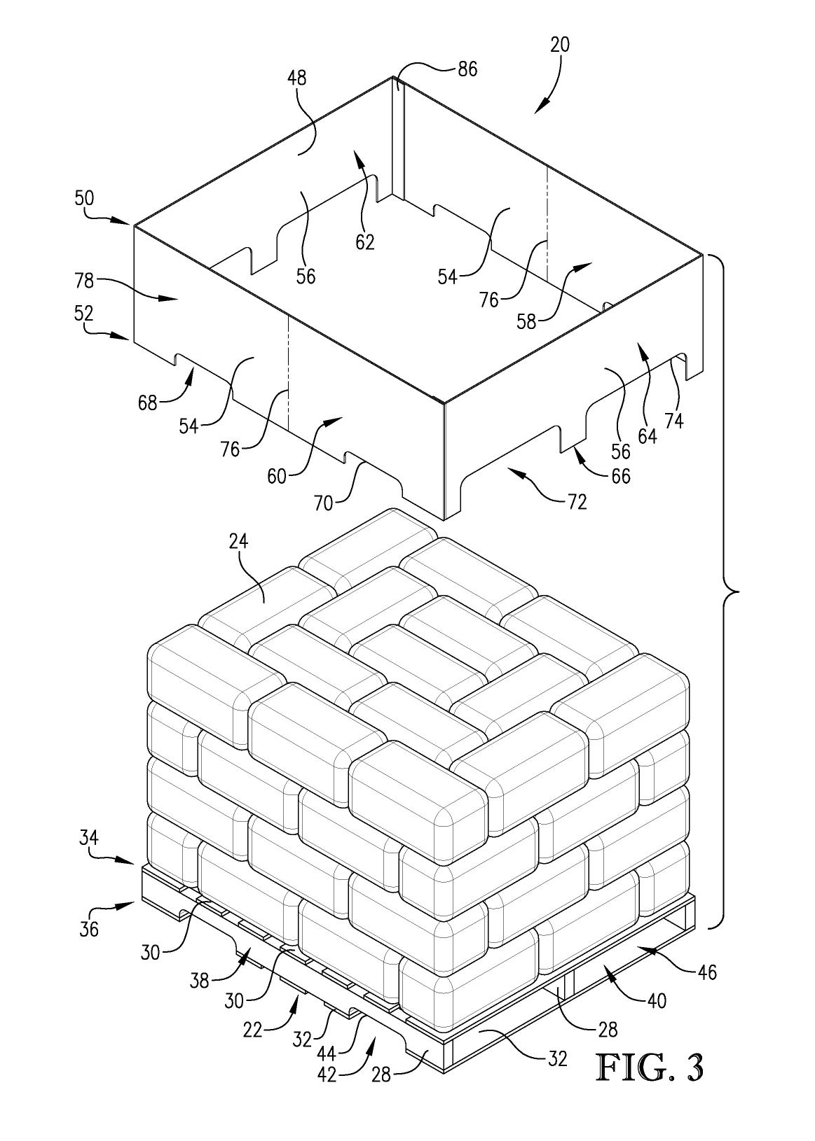

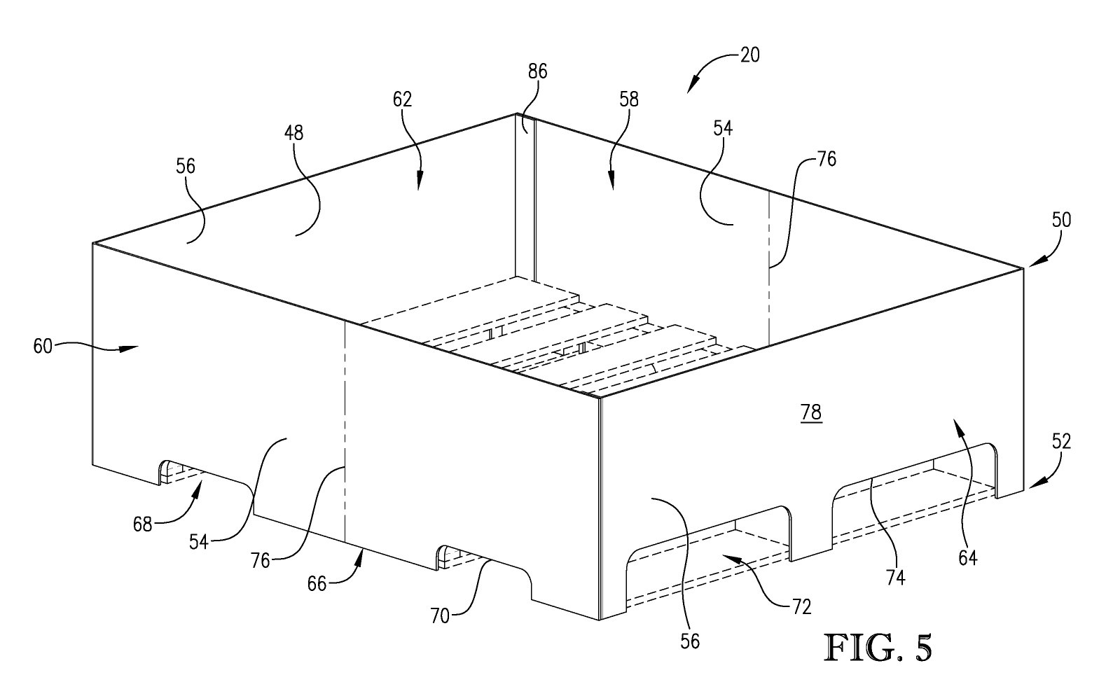

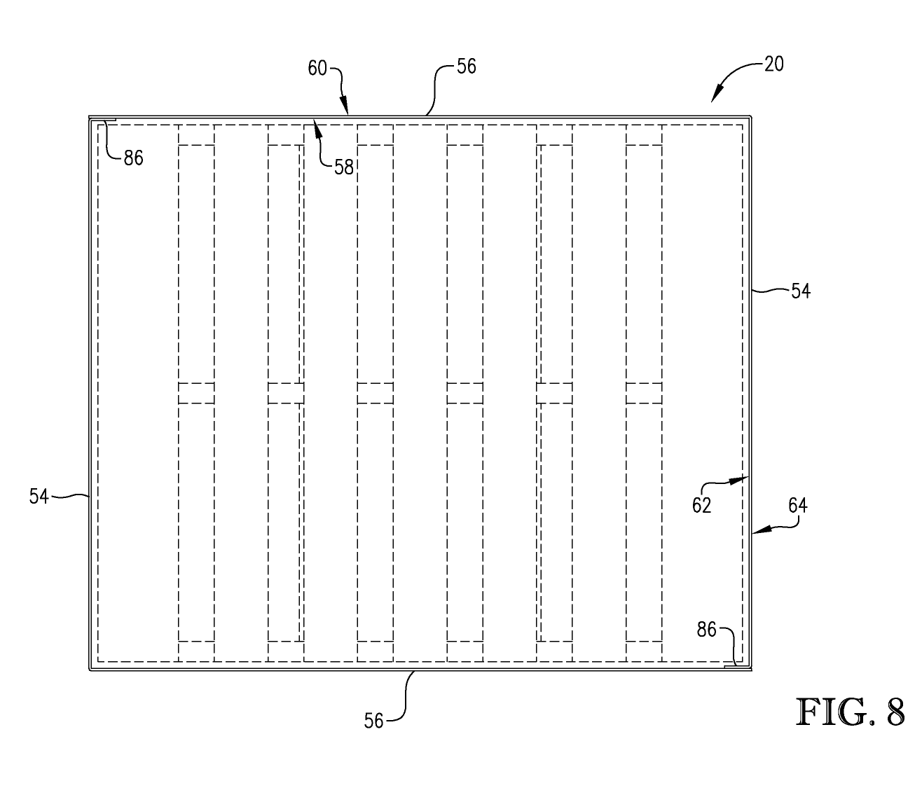

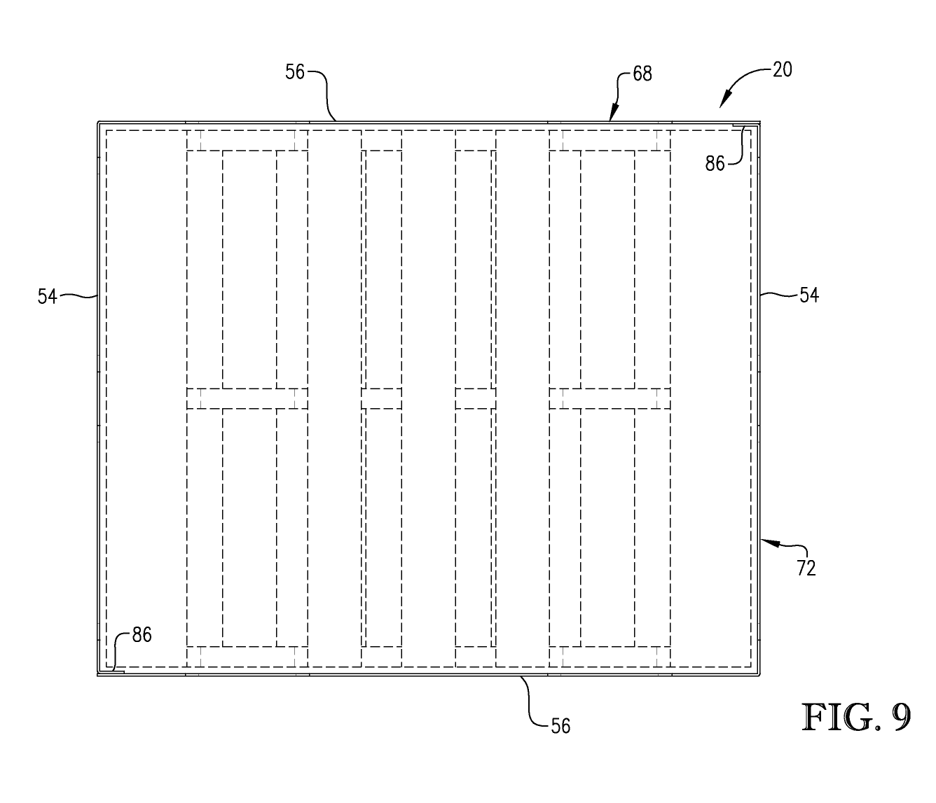

With reference generally to FIGS. 1-9, and with initial reference specifically to FIG. 1, a pallet skirt 20 constructed in accordance with the principles of an embodiment of the present invention is shown disposed about a pallet 22 with a product 24 stacked thereon. As will be readily understood by one of ordinary skill in the art, the pallet skirt 20 and the stacked product 24 are both at least partially wrapped with a wrapping material 26, such as a plastic film or other suitable material.

With particular reference to FIGS. 1, 3, and 4, the pallet 22 is generally conventional, and specifically includes a plurality of notched stringers 28, a plurality of top deck boards 30, and a plurality of bottom deck boards 32. The plurality of top deck boards 30 cooperatively define a substantially flat and generally horizontal top surface 34 of the pallet 22. The plurality of bottom deck boards 32 cooperatively define a substantially flat and generally horizontal bottom surface 36 of the pallet 22.

The pallet 22 also includes a first pair of opposite side portions 38 and a second pair of opposite side portions 40. Each of the first pair of opposite side portions 38 of the pallet 22 presents a pair of fork-receiving access openings 42 defined by notches 44 within the stringers 28. Each of the second pair of opposite side portions 40 of the pallet presents another pair of fork-receiving access openings 46 defined by lateral space between the stringers 28. Therefore, the illustrated pallet 22 may be lifted by forks (not shown) from any of the four side portions 38, 40, although the pallet skirt 20 of the present invention may also be used with an alternative pallet configured to be lifted by forks from fewer than all four sides, as will be readily appreciated by one of ordinary skill in the art.

The pallet 22 depicted and described herein is a standard wooden pallet with general dimensions of approximately forty-eight inches by forty inches (48 in×40 in), taken along the first side portions 38 and the second side portions 40, respectively, as is typical in the industry. Of course, many specifics of the pallet 22 depicted herein are included by way of example only, as a pallet skirt within the ambit of the present invention may be configured for use with alternative pallets of different shapes (e.g., square), sizes (e.g., half-pallets, quarter-pallets), and/or materials (e.g., metal, plastic). Thus, while the pallet skirt 20 depicted and described in detail herein is specifically configured to be disposed about the illustrated pallet 22, it will be readily appreciated by one of ordinary skill in the art that, as appropriate, the specific construction of alternative pallet skirts (not shown) may be correspondingly varied to be configured for disposal about alternative pallets without departing from the spirit of the present invention. Additionally, the pallet skirt 20 may be alternatively configured for use with other product-holding containers, such as open-top containers or other pallet-type devices.

With attention still to FIGS. 1-9, the depicted pallet skirt 20 will be described in further detail. The pallet skirt 20 is configured for covering the side portions 38, 40 of the pallet 22 and for providing access for mechanical lifting of the pallet 22 via forks of a pallet lifting device (not shown). The pallet skirt 20 broadly includes a skirt body 48. The skirt body 48 presents a top margin 50 and an opposite bottom margin 52.

The skirt body 48 includes a first pair of opposite side walls 54 and a second pair of opposite side walls 56. Each of the first side walls 54 presents an inner face 58 and an opposite outer face 60. Similarly, each of the second side walls 56 presents an inner face 62 and an opposite outer face 64.

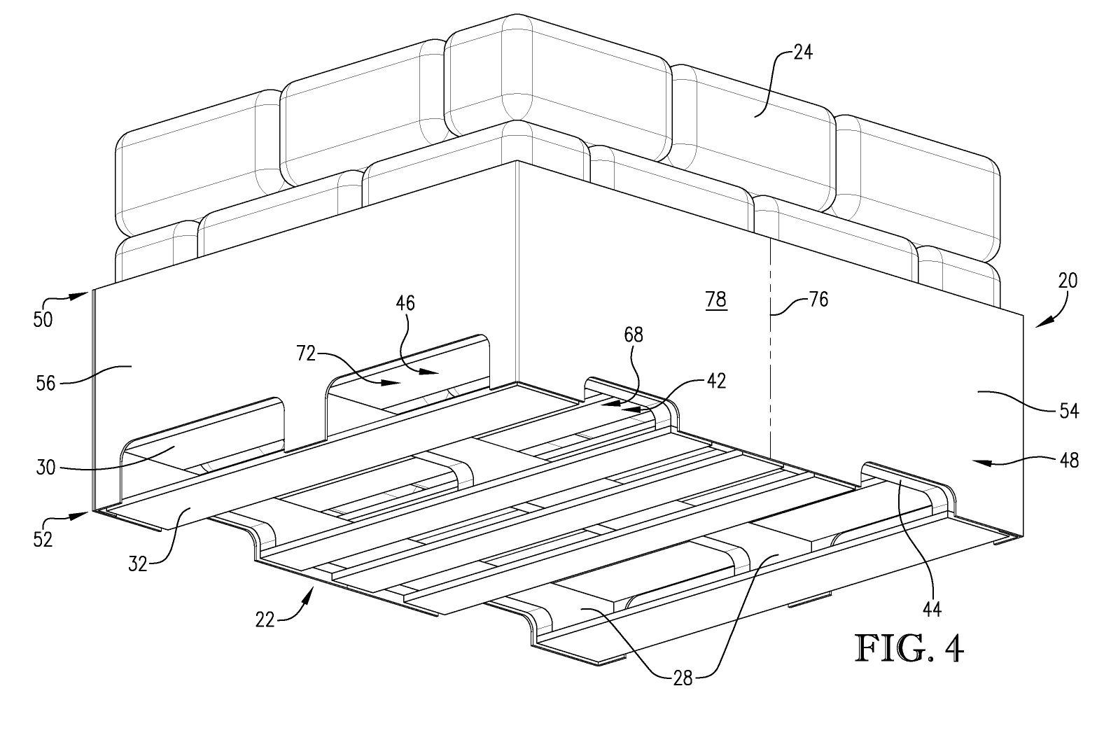

As shown particularly in FIGS. 1 and 4, the skirt body 48 is configured to be disposed about the pallet 22. In more detail, the side walls 54, 56 are configured to cooperatively cover portions of the product 24 stacked on the pallet 22, and also to cooperatively cover the side portions 38, 40 of the pallet 22 when the skirt body 48 is disposed about the pallet 22. In even greater detail, the skirt body 48 includes a lowermost part 66 of the bottom margin 52, with the lowermost part 66 of the bottom margin 52 of the skirt body 48 being disposed in line with the bottom surface 36 of the pallet 22 when the skirt body 48 is disposed about the pallet 22 (as shown in FIGS. 1 and 4).

In the preferred embodiment, the skirt body 48 is configured to be disposed about the pallet 22 (around the side portions 38, 40), but not on top of the top surface 34 of the pallet 22. Therefore, the skirt body 48 is preferably devoid of any bottom wall (not shown) extending between opposite side walls 54, 56.

Also in the illustrated embodiment, the side walls 54, 56 preferably, although not necessarily, extend generally vertically and substantially orthogonal to the top surface 34 of the pallet 22. It will also be readily appreciated that, based on general dimensions of the conventional pallet depicted and described herein, each side wall 54 of the first side wall pair is longer than each side wall 56 of the second side wall pair.

In the embodiment of the pallet skirt 20 depicted in FIGS. 1-9, each side wall 54 of the first side wall pair defines therethrough a first pair of spaced apart fork-receiving recesses 68. In more detail, each recess 68 of the first pair of fork-receiving recesses presents a first recesses margin 70 that is spaced from the lowermost part 66 of the bottom margin 52. Each recess 68 of the first pair of fork-receiving recesses extends between the inner face 58 and the outer face 60 to thereby provide fork access to the pallet 22 through the side wall 54 when the skirt body 48 is disposed about the pallet 22. In even greater detail, as shown particularly in FIGS. 1 and 4, each recess 68 of the first pair of fork-receiving recesses lines up with and corresponds to a respective fork-receiving access opening 42 of the pallet 22, as will be readily appreciated by one of ordinary skill in the art.

Also in the embodiment of the pallet skirt 20 depicted in FIGS. 1-9, each side wall 56 of the second side wall pair defines therethrough a second pair of spaced apart fork-receiving recesses 72. In more detail, each recess 72 of the second pair of fork-receiving recesses presents a second recesses margin 74 that is spaced from the lowermost part 66 of the bottom margin 52. Each recess 72 of the second pair of fork-receiving recesses extends between the inner face 62 and the outer face 64 to thereby provide fork access to the pallet 22 through the side wall 56 when the skirt body 48 is disposed about the pallet 22. In even greater detail, as shown particularly in FIGS. 1 and 4, each recess 72 of the second pair of fork-receiving recesses lines up with and corresponds to at least a portion of a respective fork-receiving access opening 46 of the pallet 22, as will be readily appreciated by one of ordinary skill in the art.

In the illustrated embodiment, the bottom margin 52 of the skirt body 48 defines both the first pair of recesses 68 and a second pair of recesses 72, such that the recess margins 68, 72 are part of the bottom margin 52 of the skirt body 48. In this way, the bottom margin 52 of the skirt body 48 is substantially continuous. Of course, it remains entirely within the ambit of the present invention for either or both of the first and second pairs of recesses 68, 72 to be alternatively defined such that the respective recess margins 68, 72 are not part of the substantially continuous bottom margin 52 of the skirt body 48.

In even more detail with regard to the illustrated embodiment, each recess 68 of the first pair of fork-receiving recesses is preferably shaped to be generally symmetrical with one another, although such symmetry is not required. Similarly, each recess 72 of the second pair of fork-receiving recesses is also preferably shaped to be generally symmetrical with one another, although such symmetry is not required. In the embodiment depicted herein, the first recesses 68 are smaller than the second recesses 72, although all of the recesses 68, 72 may alternatively be the same size (or the first recesses 68 may even be larger than the second recesses 72) depending on the size and shape of corresponding access opening of an alternative pallet (not shown), as will be readily understood by one of ordinary skill in the art.

Also in the illustrated embodiment, the top margin 50 of the skirt body 48 is substantially linearly continuous, although alternative profiles for the top margin 50 of the skirt body 48 may be formed without departing from the spirit of the present invention.

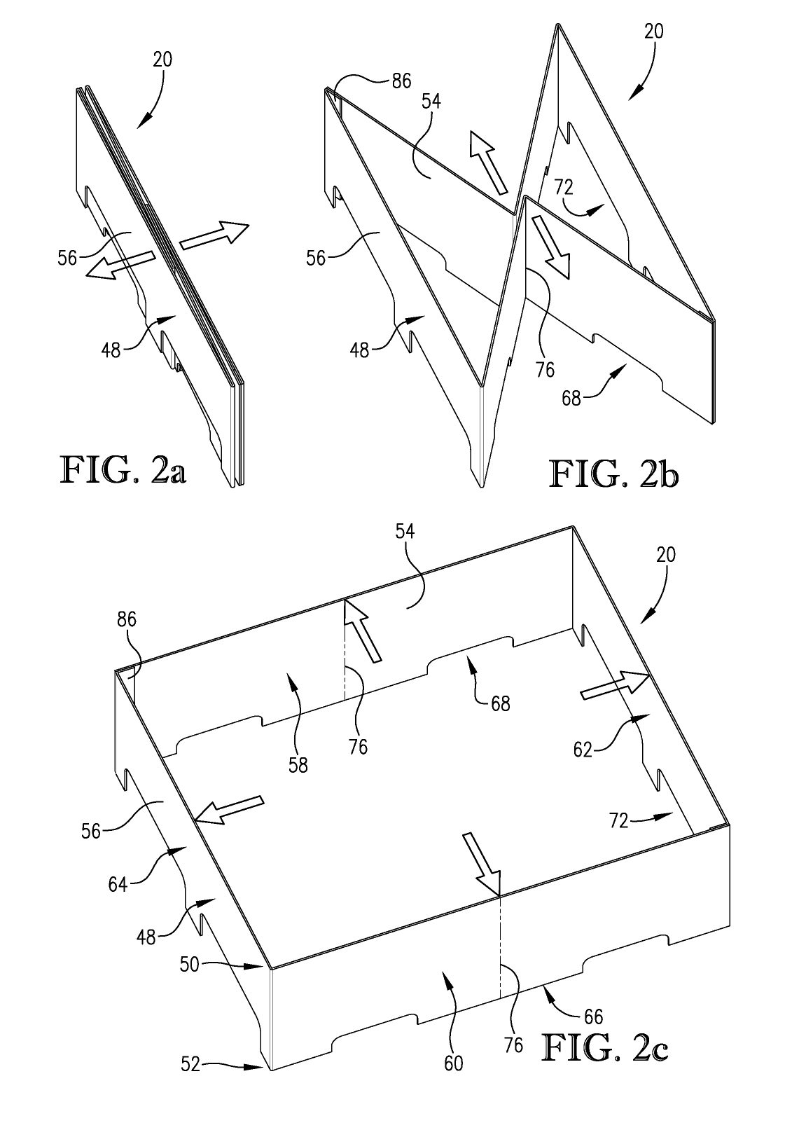

With particular respect now to FIGS. 2a, 2b, and 2c, it will be readily apparent to one of ordinary skill in the art that the skirt body 48 is foldable along intersections of adjacent first and second side walls 54, 56, such that the skirt body 48 may be collapsed to lay flat when not disposed about the pallet 22. In more detail, each of the first side walls 54 includes generally centrally disposed vertical crease lines 76, such that respective portions of the outer face 60 on either side of the crease lines 76 are brought together upon folding of the skirt body 48. When the skirt body 48 is folded into a collapsed condition (see FIG. 2a), a plurality of such skirt bodies may be efficiently stored until such time as one of the skirt bodies is expanded (see FIGS. 2b and 2c) for disposition about the pallet 22.

As will be readily understood by one of ordinary skill in the art, each of the outer faces 60, 64 of the side walls 54, 56 defines a printable messaging space 78 thereon. The printable messaging space 78 on each of the side walls 54, 56 extends substantially continuously from the top margin 50 to the bottom margin 52. Furthermore the printable messaging space 78 on each of the side walls 54, 56 includes portions of the outer faces 60, 64 that are disposed laterally adjacent and between the respective recesses 68, 72.

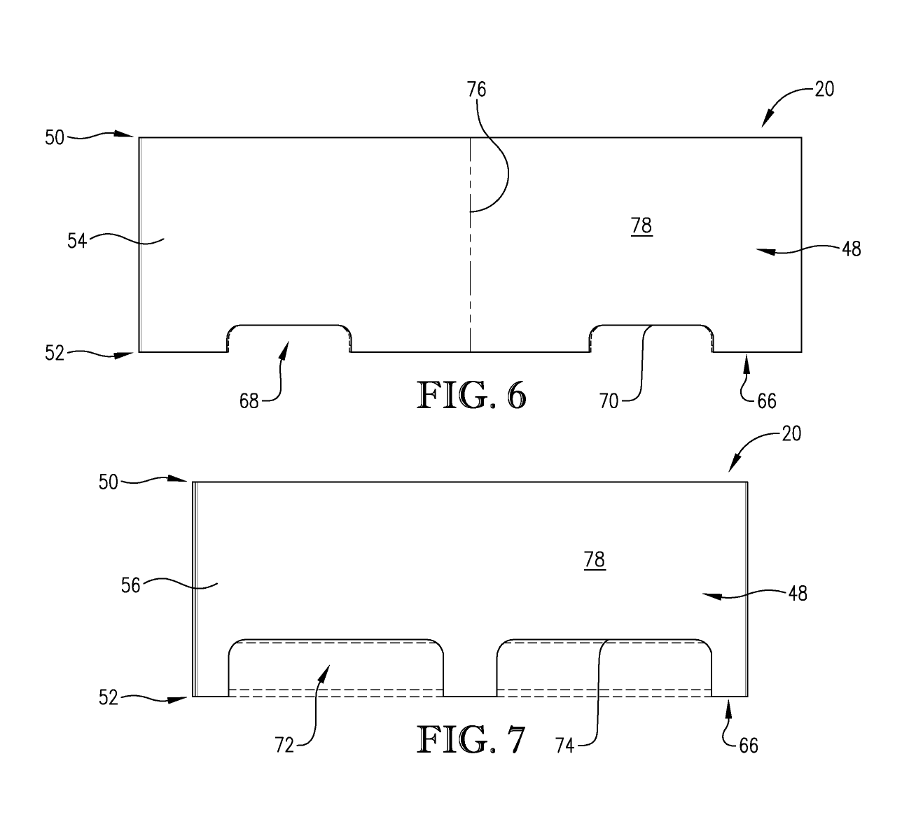

In abundant detail regarding the depicted embodiment, and with reference especially to FIGS. 6 and 7, approximate sample dimensions of portions of the skirt body 48 will be described. Looking first to FIG. 6, the outer face 60 of the first side wall 54 presents a horizontal length dimension of approximately forty-nine and one-half inches (49.5 in) and a vertical height dimension of approximately sixteen inches (16 in). Each of the first recesses 68 spans a horizontal length dimension between portions of the side wall 54 of approximately nine and one-quarter inches (9.25 in) and spans a vertical height dimension between the lowermost part 66 of the bottom margin 52 and the first recess margin 70 of approximately two inches (2 in). Thus, each of the first side walls 54 presents messaging space 78 on the outer face 60 thereof of at least approximately seven hundred fifty-five square inches (755 in²).

Looking next to FIG. 7, the outer face 64 of the second side wall 56 presents a horizontal length dimension of approximately forty-one and one-half inches (41.5 in) and a vertical height dimension of approximately sixteen inches (16 in). Each of the second recesses 72 spans a horizontal length dimension between portions of the side wall 56 of approximately sixteen inches (16 in) and spans a vertical height dimension between the lowermost part 66 of the bottom margin 52 and the second recess margin 74 of approximately four and one-quarter inches (4.25 in). Thus, each of the second side walls 56 presents messaging space 78 on the outer face 64 thereof of at least approximately five hundred twenty square inches (520 in²). The large amount of messaging space 78 on each of the outer faces 60, 64 may be very advantageous for labeling the palleted product 24.

A method of labeling the product 24 on the pallet 22 such that the labeled pallet is movable via forks of a pallet lifting device should be readily apparent to one of ordinary skill in the art from the detailed description of the printable pallet skirt 20 described above, and therefore will be described herein only briefly. Initially, the product 24 may be efficiently loaded onto the pallet 22 with an automatic palletizer (not shown), as will be readily understood.

Next, the pallet skirt 20 may be disposed about the pallet 22 to cover portions of the product 24 and to cover side portions 38, 40 of the pallet 22. The pallet skirt 20 is disposed such that the lowermost part 66 of the bottom margin 52 of the skirt 20 is in line with the bottom surface 36 of the pallet 22. If desired, the pallet skirt 20 may be secured directly to the pallet 22, such as by stapling, or the pallet skirt 20 may be sufficiently held in place by a friction fit over the product 24 and the pallet 22. The skirt 20 includes the plurality of side walls 54, 56, with at least one of the side walls 54, 56 defining therethrough a pair of the spaced apart fork-receiving recesses 68, 72 through which forks (not shown) can extend to access and lift the labeled pallet 22 while the skirt 20 is disposed thereabout.

The wrapping material 26 may then be wrapped around at least a portion of the loaded product 24 and around a portion of the pallet skirt 20. The wrapping material 26 is preferably wrapped around the portion of the pallet skirt 20 above the recesses 68, 72, such that the labeled and wrapped pallet 22 is movable via forks without puncturing the wrapping material 26. Of course, it remains firmly within the ambit of the present invention for the wrapping material 26 to be alternatively wrapped around either or both of the recesses 68, 72, such that forks of a lifting device may puncture through parts of the wrapping material 26 as the pallet 22 is moved. In this way, the labeled and wrapped pallet 22 may be moved with forks of the pallet lifting device by inserting the forks through selected ones of the recesses 68, 72 to engage appropriate lifting structure of the pallet, as will be readily understood by one of ordinary skill in the art upon review of this disclosure.

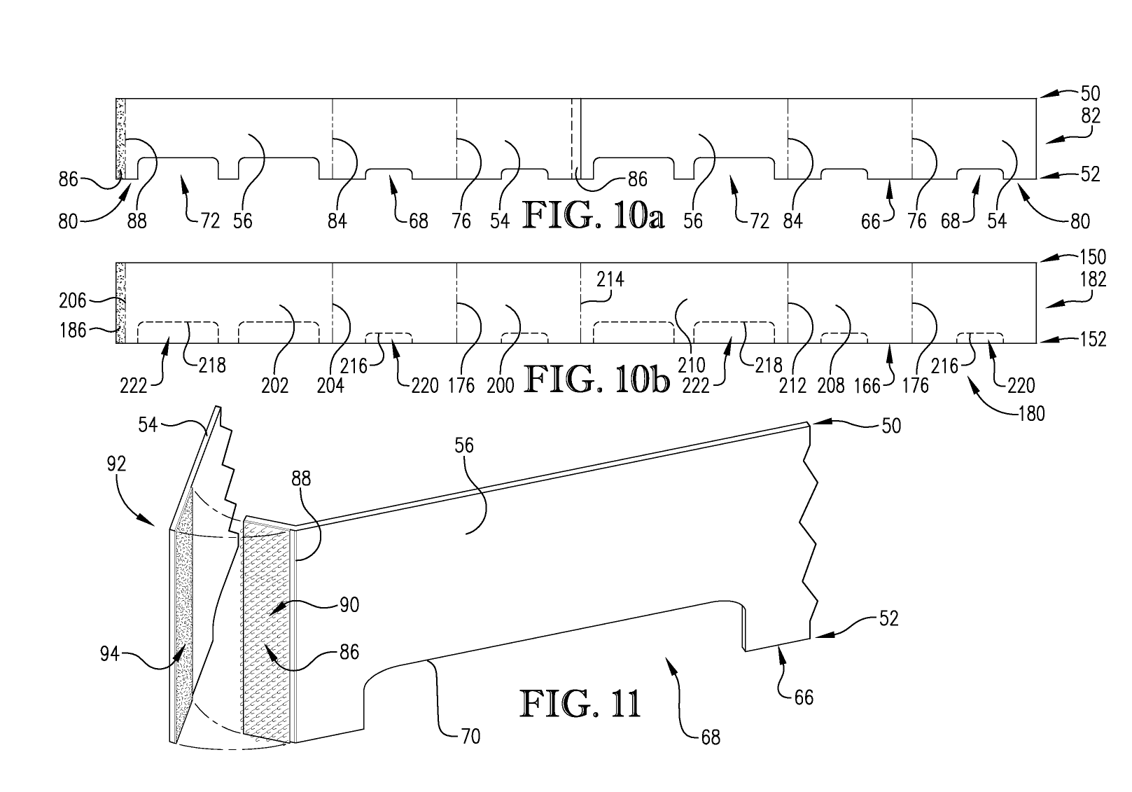

Turning now to FIGS. 10a, 10b, and 11, it will be readily understood by one of ordinary skill in the art upon review of this disclosure that a pallet skirt, such as the pallet skirt 20, may be formed from an appropriate blank or blanks. With attention first to FIG. 10a, a pair of identical elongated blanks 80 is depicted, with the pair of blanks 80 being secured to one another to form the pallet skirt 20 as shown in FIGS. 1-9 and described in detail above. Thus, for the sake of brevity, additional description of the duplicate elements and features will be avoided, and the reference numbers of identical individual components will be maintained to correspond to the components described in detail above, as will be readily appreciated by one of ordinary skill in the art.

With continued reference to FIG. 10a, each blank 80 comprises an elongated sheet of skirt material 82, such as printable cardboard. Each blank 80 includes one of each of the side walls 54, 56, with the side walls 54, 56 being disposed laterally adjacent one another and having a first fold line 84 disposed therebetween. Each blank 80 further includes a connection flap 86 disposed laterally adjacent the second side wall 56 and having a second fold line 88 disposed therebetween. More specifically with respect to FIG. 10a, the connection flap 86 extends laterally beyond the second side wall 56, with the connection flap 86 being configured to couple with the first side wall 54 of another blank 80. In more detail, the connection flap 86 includes a connection surface 90 disposed adjacent the outer face 64 of the second side wall 56. The first side wall 54 presents an end margin 92 that includes a corresponding connection surface 94 disposed on the inner face 58 thereof.

With attention briefly to FIG. 11, the connection surfaces 90, 94 may comprise a selectively releasable connection structure, such as hook-and-loop fasteners. It is believed that selectable release and reattachment of the connection surfaces 90, 94 may be advantageous in some applications of the pallet skirt 20, with alternative incorporation of other types of releasable fasteners being firmly within the ambit of the present invention. Alternatively, the connection surfaces may be permanently connected (e.g., with a glue or other adhesive) without departing from the teachings of the present invention.

With attention briefly now to FIG. 10b, a blank 180 constructed in accordance with the principles of another embodiment of the present invention is shown. As will be readily appreciated by one of ordinary skill in the art upon review of FIGS. 10a and 10b, the blank 180 is very similar to the blank 80 described in detail above, with the exception of the blank 180 comprising a single elongated sheet of skirt material 182 and detail distinctions regarding recess-defining margins described in detail below.

Therefore, for the sake of brevity, additional description of the duplicate elements and features will be avoided, and the reference numbers of any corresponding or similar individual components will be numbered to correspond to the components described above (incremented by an order of one hundred), as will be readily appreciated by one of ordinary skill in the art. Any new or different components or features unique to the blank 180 are numbered starting at two hundred. As will be abundantly clear to one of ordinary skill in the art upon review of this disclosure, only the distinctions between the blank 180 and the blank 80 will be described herein below, with all other elements being sufficiently described in detail above.

With continued reference to FIG. 10b, the blank 180 includes the elongated sheet of skirt material 182, such as printable cardboard. The sheet 182 includes first and second side wall panels 200, 202, with the side wall panels 200, 202 being disposed laterally adjacent one another and having a first fold line 204 disposed therebetween. The sheet 182 further includes a connection flap 186 disposed laterally adjacent the second side wall panel 202 and having a second fold line 206 disposed therebetween. In more detail with respect to FIG. 10b, the connection flap 186 is configured to connect with another side wall panel of the same sheet 182.

The sheet 182 further includes third and fourth side wall panels 208, 210, with the side wall panels 208, 210 being disposed laterally adjacent one another and having a third fold line 212 disposed therebetween. The fourth side wall panel 210 is disposed laterally adjacent the first side wall panel 200, with a fourth fold line 214 disposed therebetween. As will be readily appreciated by one of ordinary skill in the art, the connection flap 186 is configured to connect with the third side wall panel 208 to form a pallet skirt. In more detail, the first side wall panel 200 and the third side wall panel 208 are preferably generally symmetrical with respect to one another. Also, the second side wall panel 202 and the fourth side wall panel 210 are also preferably generally symmetrical with respect to one another.

As shown in FIG. 10b, each of the side wall panels 200, 202, 208, 210 includes a pair of spaced apart recess-defining margins 216, 218 defined therein to selectively present a recess margin that is spaced from a lowermost part 166 of the bottom margin 152.

In the illustrated embodiment, each of the side wall panels 200, 202, 208, 210 includes a respective pair of spaced apart knockouts 220, 222 being defined therein by the recess-defining margins 216, 218. The recess-defining margins 216, 218 preferably take the form of lines of weakness, such that the knockouts 220, 222 are selectively removable to define recesses.

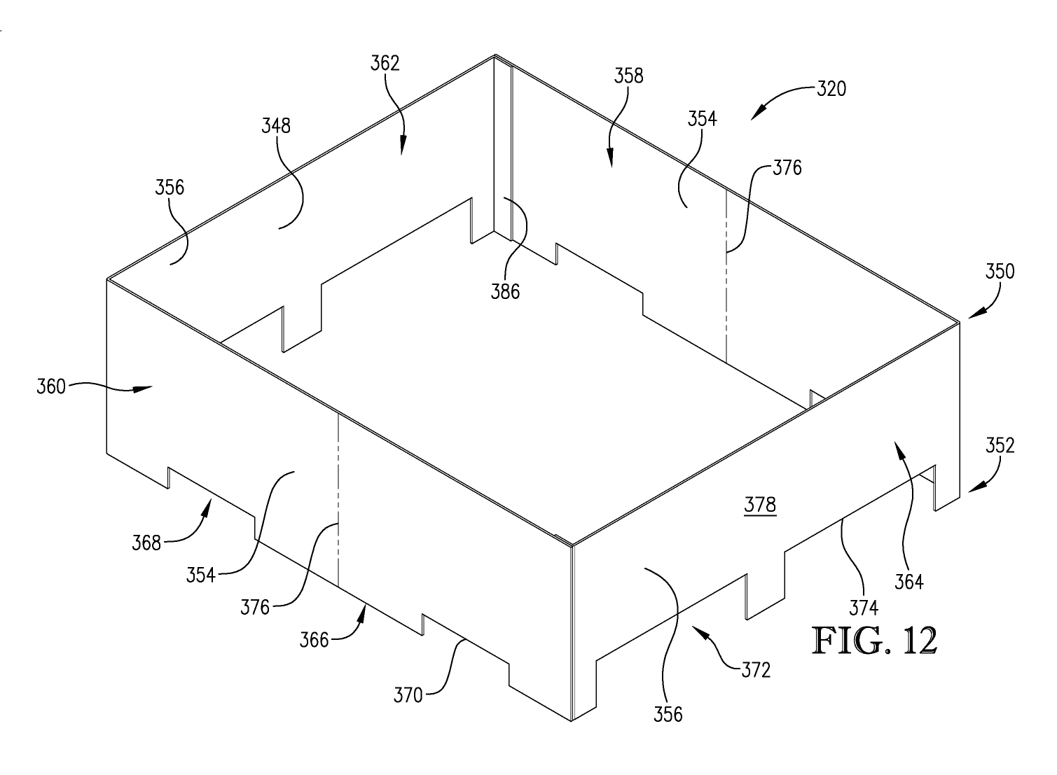

With attention very briefly now to the additional pallet skirt embodiments depicted in FIGS. 12-14, it is noted that each of these pallet skirts is very similar to the pallet skirt 20 described in detail above, with the exception of detail distinctions described below.

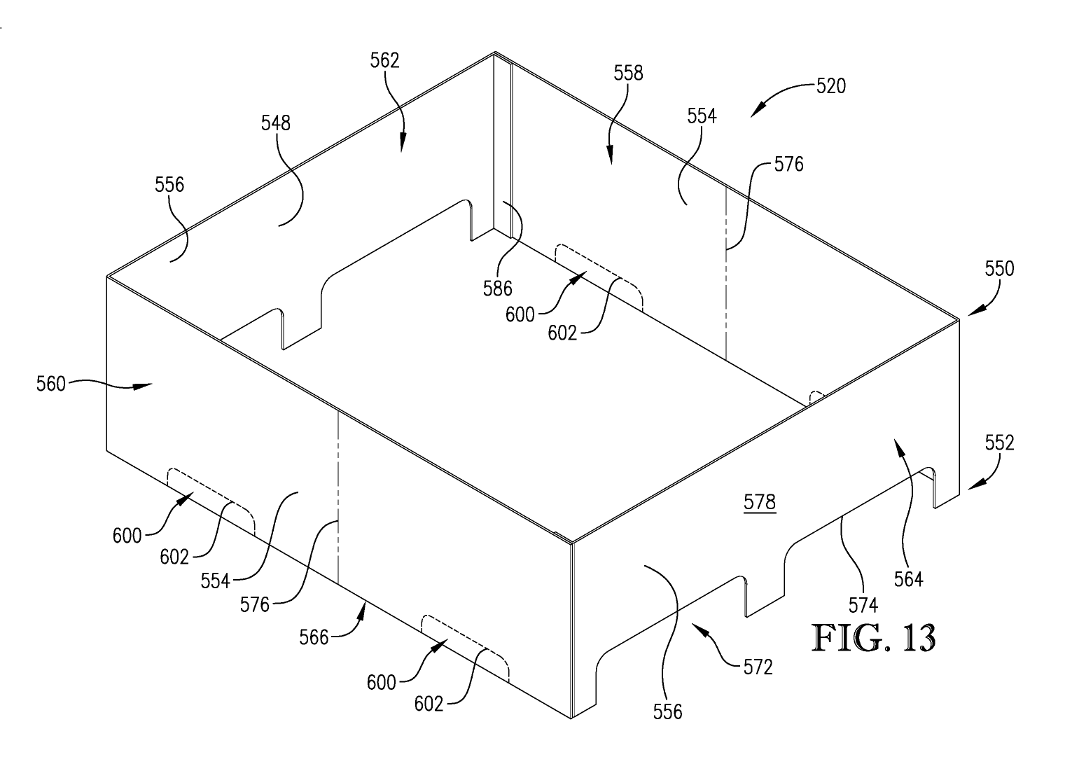

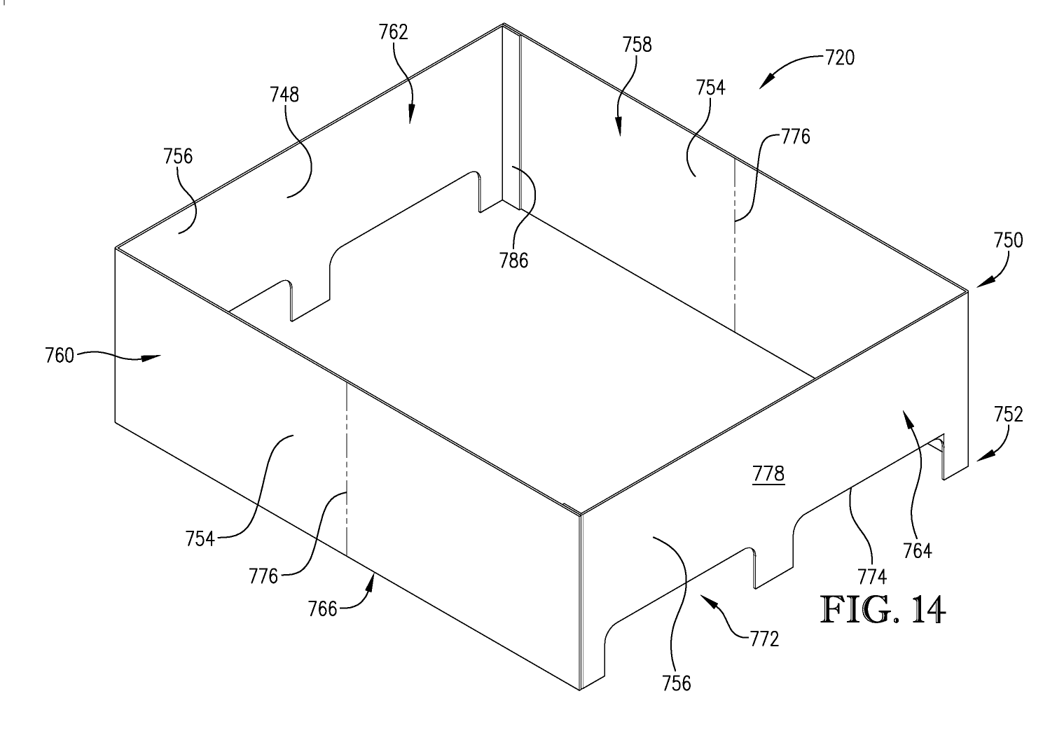

Therefore, for the sake of brevity, additional description of the duplicate elements and features will be avoided, and the reference numbers of any corresponding or similar individual components will be numbered to correspond to the components described above (incremented by an order of three hundred for FIG. 12; incremented by an order of five hundred for FIG. 13; and incremented by an order of seven hundred for FIG. 14), as will be readily appreciated by one of ordinary skill in the art. Any new or different components or features unique to the additional pallet skirt 320 of FIG. 12 are numbered starting at four hundred; any new or different components or features unique to the additional pallet skirt 520 of FIG. 13 are numbered starting at six hundred; and any new or different components or features unique to the additional pallet skirt 720 of FIG. 14 are numbered starting at eight hundred. As will be abundantly clear to one of ordinary skill in the art upon review of this disclosure, only the distinctions between the pallet skirt 20 and the additional pallet skirts 320, 520, and 720 will be described herein below, with all other elements being sufficiently described in detail above.

With brief reference first to FIG. 12, the pallet skirt 320 is substantially the same as the pallet skirt 20 described in detail above, with the exception of differently shaped recesses 368, 372. More specifically, the recesses 368, 372 include generally right-angle internal corners (as opposed to the generally arcuate or rounded internal corners of the recesses 68, 72 of the pallet skirt 20). Furthermore, it will be readily apparent to one of ordinary skill in the art upon review of this disclosure that additional shapes for alternative recesses (not shown) may be incorporated into alternative pallet skirts without departing from the teachings of the present invention.

With brief reference next to FIG. 13, the pallet skirt 520 is substantially the same as the pallet skirt 20 described in detail above, with the exception that only the second side walls 556 define recesses 572 therein. The first side walls 554 instead include respective pairs of spaced apart knockouts 600 being defined therein by lines of weakness 602, such that the knockouts 600 are selectively removable to define recesses.

Finally, with brief reference to FIG. 14, the pallet skirt 720 is substantially the same as the pallet skirt 20 described in detail above, with the exception that only the second side walls 756 define recesses 772 therein. The first side walls 754 are instead devoid of any recesses, lines of weakness, or other forms of recess margins.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and access the reasonably fair scope of the present invention as pertains to any apparatus not materially departing from but outside the literal scope of the invention set forth in the following claims.

1. A pallet skirt for covering side portions of a pallet and for providing access for mechanical lifting of the pallet via forks of a pallet lifting device, said pallet skirt comprising:
a skirt body presenting opposite top and bottom margins,
said skirt body including a first pair of opposite side walls and a second pair of opposite side walls,
each of said side walls presenting opposite inner and outer faces,
said side walls being configured to cooperatively cover portions of product stacked on the pallet and to cooperatively cover side portions of the pallet, such that a lowermost part of the bottom margin of the skirt body is in line with a bottom surface of the pallet, when the skirt body is disposed about the pallet,
said side walls of at least one of the side wall pairs defining therethrough a pair of spaced apart fork-receiving recesses that extend between the inner and outer faces and thereby provide fork access to the pallet through the side wall when the skirt body is disposed about the pallet.

2. The pallet skirt as claimed in claim 1,
each recess presenting a recess margin that is spaced from the lowermost part of the bottom margin.

3. The pallet skirt as claimed in claim 2,
said bottom margin defining the recesses, such that the bottom margin is substantially continuous.

4. The pallet skirt as claimed in claim 1,
each side wall of the first side wall pair defining a first pair of the fork-receiving recesses,
each side wall of the second side wall pair defining a second pair of the fork-receiving recesses.

5. The pallet skirt as claimed in claim 4,
each recess of said first pair of recesses being generally symmetrical with one another,
each recess of said second pair of recesses being generally symmetrical with one another.

6. The pallet skirt as claimed in claim 5,
said recesses of the first pair of recesses being smaller than the recesses of the second pair of recesses.

7. The pallet skirt as claimed in claim 1,
said outer faces of the side walls defining thereon a printable messaging space, such that the messaging space extends substantially continuously from the top margin to the bottom margin,
said messaging space including portions of the outer faces disposed laterally adjacent and between the recesses.

8. The pallet skirt as claimed in claim 1,
said skirt body being devoid of any bottom wall extending between opposite side walls.

9. The pallet skirt as claimed in claim 1,
said skirt body being configured to be disposed about the pallet subsequent to product being loaded onto the pallet,
said skirt body being further configured to be at least partially wrapped with a wrapping material.

10. The pallet skirt as claimed in claim 1,
said side walls extending generally vertically and substantially orthogonal to a top surface of the pallet,
each side wall of the first side wall pair being longer than each side wall of the second side wall pair.

11. The pallet skirt as claimed in claim 1,
said skirt body being foldable along intersections of adjacent side walls, such that the skirt body may be collapsed to lay flat, when the skirt body is not disposed about the pallet,
said side walls of at least one of the side wall pairs including generally centrally disposed vertical crease lines, such that respective portions of the outer face on either side of each crease line are brought together upon folding of the skirt body.

12. The pallet skirt as claimed in claim 1,
said skirt body being formed of a plurality of identical elongated blanks,
each blank including at least one side wall and a connection flap that extends laterally beyond the side wall, with the connection flap being configured to couple with a respective side wall of another blank.

13. The pallet skirt as claimed in claim 12,
each connection flap including a connection surface disposed adjacent the outer face of the side wall,
each blank presenting a lateral end margin opposite the connection flap that includes a corresponding connection surface disposed on the inner face thereof,
said connection surfaces being configured to selectively secure the plurality of blanks to one another.

14. The pallet skirt as claimed in claim 13,
said connection surfaces comprising selectively releasable connection structure.

15. A blank for forming a pallet skirt, where the skirt is to be configured to cover side portions of a pallet and to provide access for mechanical lifting of the pallet via forks of a pallet lifting device when the skirt is disposed about the pallet, said blank comprising:
an elongated sheet of skirt material,
said sheet presenting opposite top and bottom margins,
said sheet including first and second side wall panels, with the side wall panels being disposed laterally adjacent one another and having a first fold line disposed therebetween, and with each of the side wall panels extending substantially continuously between the top and bottom margins,
said sheet further including a connection flap disposed laterally adjacent one of the side wall panels and having a second fold line disposed therebetween, with the connection flap being configured to connect with another side wall panel of either the same sheet or another sheet,
at least one of the side wall panels including a pair of spaced apart recess-defining margins being defined therein to selectively present a recess margin that is spaced from a lowermost part of the bottom margin.

16. The blank for forming a pallet skirt as claimed in claim 15,
said sheet comprising printable cardboard.

17. The blank for forming a pallet skirt as claimed in claim 15,
said at least one of the side wall panels including a pair of spaced apart knockouts being defined therein by the recess-defining margins,
said recess-defining margins comprising lines of weakness, such that the knockouts are selectively removable to define recesses.

18. The blank for forming a pallet skirt as claimed in claim 15,
said at least one of the side wall panels including a pair of spaced apart recesses being defined therein by the recess-defining margins.

19. The blank for forming a pallet skirt as claimed in claim 18,
said bottom margin defining the recesses, such that the bottom margin is substantially continuous.

20. The blank for forming a pallet skirt as claimed in claim 19,
said first side wall panel including a first pair of the recesses and said second side wall panel including a second pair of the recesses,
each recess of said first pair of recesses being generally symmetrical with one another and each recess of said second pair of recesses being generally symmetrical with one another,
said recesses of the first pair of recesses being smaller than the recesses of the second pair of recesses.

21. The blank for forming a pallet skirt as claimed in claim 15,
said sheet further including third and fourth side wall panels, with the side wall panels being disposed laterally adjacent one another and having a third fold line disposed therebetween, and with each of the side wall panels extending substantially continuously between the top and bottom margins,
said third side wall panel being disposed laterally adjacent the second side wall panel and having a fourth fold line disposed therebetween,
said connection flap being configured to connect with the fourth side wall panel.

22. The blank for forming a pallet skirt as claimed in claim 21,
said first and third side wall panels being generally symmetrical with one another,
said second and fourth side wall panels being generally symmetrical with one another.

23. The blank for forming a pallet skirt as claimed in claim 15,
said blank further comprising a second sheet configured the same as the first-mentioned sheet,
said connection flap of the second sheet being configured to connect with the second side wall panel of the first-mentioned sheet,
said connection flap of the first-mentioned sheet being configured to connect with the second side wall panel of the second sheet.

24. A foldable pallet skirt selectively formed from a pair of blanks as claimed in claim 15,
said connection flap of each blank including a connection surface and a portion of said respective side wall of each blank including a corresponding connection surface, such that the pair of blanks are selectively coupled with one another.

25. A method of labeling product on a pallet such that the labeled pallet is moveable via forks of a pallet lifting device, said labeling method comprising the step of:
disposing a labeling pallet skirt according to claim 1 about the pallet to cover portions of the product and to cover side portions of the pallet, such that said lowermost part of said bottom margin of the skirt is in line with said bottom surface of the pallet.

26. The labeling method as claimed in claim 25,
said method further comprising the step of loading product onto the pallet with an automatic palletizer prior to disposing the labeling pallet skirt about the pallet.

27. The labeling method as claimed in claim 25,
said method further comprising the step of wrapping a material around at least a portion of the loaded product and around a portion of the pallet skirt.

28. The labeling method as claimed in claim 27,
said wrapping step including the step of wrapping the material around the portion of the pallet skirt above the recesses, such that the labeled and wrapped pallet is moveable via forks of the pallet lifting device.

29. The labeling method as claimed in claim 25,
said method further comprising the step of moving the labeled pallet with forks of the pallet lifting device by inserting the forks through the recesses to engage lifting structure of the pallet.
